(19) United States
(12) Patent Application Publication
(10) Pub. No.: US 2019/0003332 A1
(43) Pub. Date: Jan. 3, 2019

(54) GAS TURBINE, SEALING COVER, SEALING TELEMETRY ASSEMBLY, AND MANUFACTURING METHOD THEREOF

(71) Applicant: Siemens Aktiengesellschaft, Munich (DE)

(72) Inventors: Guo Feng CHEN, Beijing (CN); Rui Chun DUAN, Beijing (CN); Chang Peng LI, Beijing (CN); Zhi Qi YAO, Shanghai (CN)

(73) Assignee: Siemens Aktiengesellschaft, Munich (DE)

(21) Appl. No.: 16/066,760

(22) PCT Filed: Dec. 30, 2015
(86) PCT No.: PCT/CN2015/100004

§ 371 Date: Jun. 28, 2018

(51) Int. Cl. F01D 17/08; H04Q 9/00; F01D 21/00; F01D 25/28

(52) U.S. Cl. CPC F01D 17/085; H04Q 9/00; F01D 21/003; F05D 2240/55; F05D 2260/80; F05D 2270/80; F01D 25/28

(57) ABSTRACT

At least one embodiment of the present invention provides a sealing telemetry assembly used for a gas turbine. The gas turbine includes at least one turbine disk, and the sealing telemetry assembly includes a sealing cover and at least one power supply apparatus. The sealing cover is used to cover the turbine disk, and the sealing cover includes a cavity forming portion and a cover. At least one installation cavity is provided within the cavity forming portion, and the cover covers and is fixed to the cavity forming portion. The power supply apparatus is configured in the installation cavity. A gas turbine, a sealing cover, and a manufacturing method of a sealing telemetry assembly are also provided. They can improve working performance of the gas turbine, reduce production costs, and monitor an internal working environment of the gas turbine.

### PRIORITY STATEMENT

This application is the national phase under 35 U.S.C. § 371 of PCT International Application No. PCT/CN2015/100004 which has an International filing date of Dec. 30, 2015, which designated the United States of America, the entire contents of which are hereby incorporated herein by reference.

### FIELD

At least one embodiment of the present invention generally relates to the field of gas turbine technologies, and in particular, to a sealing cover used for a gas turbine, a sealing telemetry assembly, and a manufacturing method thereof.

### BACKGROUND

A gas turbine is a rotary power machine that uses air flowing continuously as a working medium and that converts thermal energy to mechanical work. The gas turbine generally includes three main components: a compressor, a combustor, and a turbine. At work, the compressor inhales air from an external atmosphere environment, and compresses the air by using an axial-flow compressor to increase pressure of the air, where at the same time, the temperature of the air also increases correspondingly. The compressed air is pressurized into the combustor and a mixture of the air and injected fuel burns to generate high temperature and high pressure gas. Then, the high temperature and high pressure gas enters the turbine and then does work by way of expansion, to push the turbine to drive the compressor and an externally loaded rotor to rotate together at a high speed, so that mechanical energy of gaseous or fluid fuel is partially converted to mechanical work, and electric work is output.

To improve reliability of the turbine, and a working status and a deformation status of a turbine component (especially a component of a high temperature) needs to be detected and monitored. Therefore, temperature sensors and pressure sensors are installed on some important components (such as the turbine blades and stationary blades of the turbine). Data sensed by the sensor is processed, so that working performance and of the turbine and lives of the components may be evaluated, which helps to take corresponding improvement measures.

According to an existing gas turbine, to implement data transmission and power supply of the sensor, through holes are provided on the turbine disk, for cables to pass. However, compared with an intact turbine disk, a working life of the turbine disk provided with the through holes may be shortened by more than ten times. Therefore, the turbine disk provided with the through holes has to be replaced before delivery to a final customer, that is, the turbine disk provided with the through holes can be used only during prototype testing, and a working status of the gas turbine still cannot be monitored in real time during actual running of the turbine. In addition, the turbine disk provided with the through holes has high manufacturing costs.

In patent of CN102124822B, a wireless telemetry apparatus used for a high temperature environment is disclosed, where the wireless telemetry apparatus may work under a high temperature environment of a gas turbine, and may transmit a sensing signal in a wireless manner, so that drilling of through holes on a turbine disk may be omitted, and a component of a high temperature of the gas turbine may be monitored in real time. However, installation of a sensor on the wireless telemetry apparatus is not mentioned in the patent.

In the patents of CN101953171A and CN102792711A, an induction power generation apparatus is disclosed, where the induction power generation apparatus may supply electric energy to a sensor, and includes an induction coil and a nanocrystallized ferromagnetic core. On the premise of desired magnetism, the nanocrystallized ferromagnetic core temperature usually works under a temperature of lower than 200 degrees Celsius, above which the magnetization will be strikingly degraded; therefore, this induction power generation apparatus cannot normally work within a gas turbine in a high temperature environment. Installation of the induction power generation apparatus results in a relatively large change of design of a turbine disk. In addition, the induction coil and the magnetic core cause a relatively large centrifugal force.

In another existing gas turbine, referring to FIG. 1, the gas turbine includes a power supply apparatus, where the power supply apparatus 102 is installed on a turbine blade 103 or a stationary blade (not shown in the figure). For isolation of a high temperature, thermal barrier coatings (TBC) are coated on the turbine blade 103 and the stationary blade. However, the thermal barrier coating is an important protective coating of the turbine blade or the stationary blade, and the installation of the power supply apparatus on the thermal barrier coating may damage the thermal barrier coating and cause the early failure.

### SUMMARY

At least one embodiment of the present invention is directed to a gas turbine, a sealing cover, a sealing telemetry assembly, and a manufacturing method thereof, which can improve working performance of the gas turbine, reduce production costs, and real-time monitor an internal working environment of the gas turbine.

At least one embodiment of the present invention provides a sealing telemetry assembly used for a gas turbine. The gas turbine includes at least one turbine disk, and the sealing telemetry assembly includes a sealing cover and at least one power supply apparatus, where the sealing cover is used to cover the turbine disk, and the sealing cover includes a cavity forming portion and a cover, where at least one installation cavity is provided within the cavity forming portion, and the cover covers and is fixed to the cavity forming portion. The power supply apparatus is configured in the installation cavity.

At least one embodiment of the present invention further provides a sealing cover used for a gas turbine, where the gas turbine includes at least one turbine disk, and the sealing cover is used to cover the turbine disk. The sealing cover includes: a cavity forming portion, where at least one installation cavity is provided within the cavity forming portion; and a cover, where the cover may cover and be fixed to the cavity forming portion.

At least one embodiment of the present invention further provides a manufacturing method of a sealing telemetry assembly, the manufacturing method comprising:

processing a cavity forming portion and a cover by using a 3D printing (additive manufacturing) technology, where at least one installation cavity is formed within the cavity forming portion;

configuring at least one power supply apparatus in the installation cavity; and

covering or fixing the cover on the cavity forming portion.

In an example embodiment of the manufacturing method of a sealing telemetry assembly, a powder material used to shape the cavity forming portion and the cover is a nickel-chromium-iron alloy.

At least one embodiment of the present invention further provides a gas turbine, where the gas turbine includes any sealing telemetry assembly described in one of the example embodiments.

At least one embodiment of the present invention provides a sealing telemetry assembly used for a gas turbine. The gas turbine includes at least one turbine disk, and the sealing telemetry assembly includes a sealing cover and at least one power supply apparatus, where the sealing cover is used to cover the turbine disk, and the sealing cover includes a cavity forming portion and a cover, where at least one installation cavity is provided within the cavity forming portion, and the cover covers and is fixed to the cavity forming portion. The power supply apparatus is configured in the installation cavity.

In an example embodiment of the sealing telemetry assembly, the cover is provided with a plurality of wire insertion holes, and when the cover covers the cavity forming portion, the wire insertion hole is in communication with a corresponding installation cavity.

In an example embodiment of the sealing telemetry assembly, the sealing telemetry assembly further includes: at least one sensor, configured in the installation cavity, where the power supply apparatus is electrically connected to the sensor.

In an example embodiment of the sealing telemetry assembly, the power supply apparatus is a thermoelectric generator.

In an example embodiment of the sealing telemetry assembly, the sealing telemetry assembly further includes: at least one spacer, where the spacer is disposed between the cover and the sensor or is disposed between the cover and the power supply apparatus.

In an example embodiment of the sealing telemetry assembly, the sealing telemetry assembly further includes: at least one wireless transmitter, where the wireless transmitter is electrically connected to the power supply apparatus and the sensor, and is configured in the installation cavity or outside the sealing cover.

At least one embodiment of the present invention further provides a sealing cover used for a gas turbine, where the gas turbine includes at least one turbine disk, and the sealing cover is used to cover the turbine disk. The sealing cover includes: a cavity forming portion, where at least one installation cavity is provided within the cavity forming portion; and a cover, where the cover may cover and be fixed to the cavity forming portion.

In an example embodiment of the sealing cover, the cover is provided with a plurality of wire insertion holes, and when the cover covers the cavity forming portion, the wire insertion hole is in communication with a corresponding installation cavity.

At least one embodiment of the present invention further provides a manufacturing method of a sealing telemetry assembly, the manufacturing method comprising:

processing a cavity forming portion and a cover by using a 3D printing (additive manufacturing) technology, where at least one installation cavity is formed within the cavity forming portion;

configuring at least one power supply apparatus in the installation cavity; and

covering or fixing the cover on the cavity forming portion.

In an example embodiment of the manufacturing method of a sealing telemetry assembly, the manufacturing method further includes:

shaping the cavity forming portion and the cover along length directions of the cavity forming portion and the cover.

In an example embodiment of the manufacturing method of a sealing telemetry assembly, the manufacturing method further includes:

performing heat treatment on the cavity forming portion and the cover.

In an example embodiment of the manufacturing method of a sealing telemetry assembly, the manufacturing method further includes:

when the cover is printed, forming a plurality of wire insertion holes on the cover, where when the cover covers the cavity forming portion, the wire insertion hole is in communication with a corresponding cavity forming portion.

In an example embodiment of the manufacturing method of a sealing telemetry assembly, the manufacturing method further includes:

configuring at least one sensor in the installation cavity, where the power supply apparatus is electrically connected to the sensor and is used to supply power to the sensor.

In an example embodiment of the manufacturing method of a sealing telemetry assembly, a powder material used to shape the cavity forming portion and the cover is a nickel-chromium-iron alloy.

At least one embodiment of the present invention further provides a gas turbine, where the gas turbine includes any sealing telemetry assembly described in one of the example embodiments.

It may be seen from the foregoing solutions that in the gas turbine, the sealing cover, the sealing telemetry assembly and the manufacturing method thereof of the present invention, the sealing cover includes a cavity forming portion and a cover, where a plurality of installation cavities are provided within the cavity forming portion, and a sensor may be accommodated within the installation cavity, which can monitor an internal environment of the gas turbine in real time.

In addition, in at least one embodiment of the present invention, a power supply apparatus is assembled in the sealing cover, which not only may avoid that a thermal barrier coating is damaged because the power supply apparatus is installed on the thermal barrier coating in the prior art, but also may avoid centrifugal force and magnetic core high temperature demagnetization problems caused by the induction power generation apparatus, so that security and reliability of the gas turbine can be improved. In addition, the sensor transmits a sensing signal in a wireless manner; therefore, no through hole for a wire to pass needs to be provided on a turbine disk, which may reduce production costs.

### BRIEF DESCRIPTION OF THE DRAWINGS

Other characteristics, features, advantages, and benefits of the present embodiments become more obvious with reference to the following detailed descriptions of the accompany drawings.

FIG. 1 is a schematic partial three-dimensional diagram of a turbine of a gas turbine in the prior art;

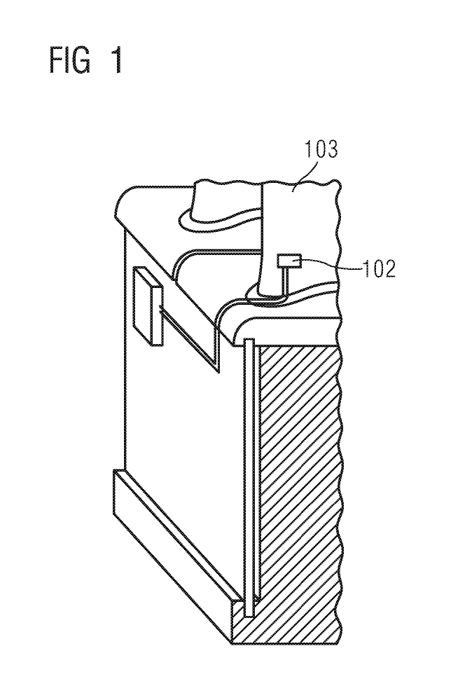

FIG. 2 is a schematic cross-sectional diagram of a gas turbine according to an embodiment of the present invention;

FIG. 3 is a schematic partial diagram of a turbine of the gas turbine shown in FIG. 2;

FIG. 4 is a schematic cross-sectional diagram of a sealing cover, along a direction, of the turbine shown in FIG. 3;

FIG. 5 is a schematic cross-sectional diagram of the sealing cover, shown in FIG. 4, along a line V-V;

FIG. 6 is a schematic cross-sectional diagram of the sealing cover, shown in FIG. 4, along a line VI-VI;

FIG. 7 is a schematic cross-sectional diagram of a sealing cover, along another direction, of the turbine shown in FIG. 3;

FIG. 8 is a schematic diagram of processing equipment that is used for manufacturing the sealing cover shown in FIG. 4; and

FIG. 9 is a schematic diagram of a manufacturing procedure of a sealing telemetry assembly shown in FIG. 4.

### DETAILED DESCRIPTION

To make the objectives, technical solutions and advantages of the present disclosure more clear, the following further describes the present invention in detail with reference to embodiments.

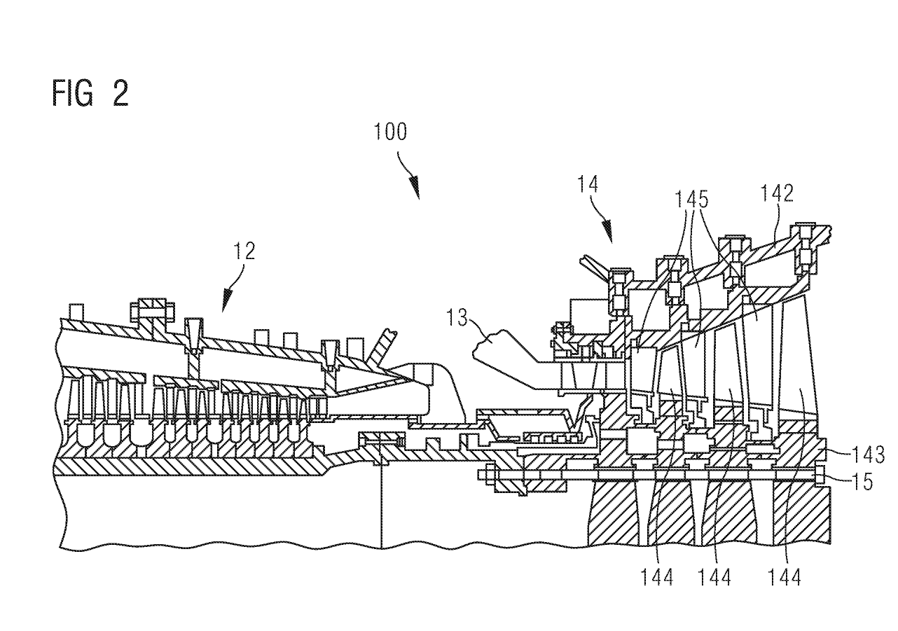

FIG. 2 is a schematic cross-sectional diagram of a gas turbine according to an embodiment of the present invention. Referring to FIG. 2, the gas turbine 100 in this embodiment includes a compressor 12, a combustor 13, and a turbine 14, where the compressor 12, the combustor 13, and the turbine 14 are sequentially disposed and communicated. A rotor 15 is further provided within the gas turbine 100, and the rotor 15 passes through the interior of the compressor 12 and the interior of the turbine 14. The turbine 14 includes a casing 142, at least one turbine disk 143 located within the casing 142, a plurality of turbine blades 144, and a plurality of stationary blades 145. The turbine disk 143 is annularly disposed on the rotor 15. In FIG. 2, there are four turbine disks 143, but the present invention is not limited thereto. A quantity of turbine disks may be set according to an actual situation. The turbine blades 144 are installed on the turbine disk 143, and are annularly arranged. The stationary blade 145 is assembled on an inner side of the casing 142, and the stationary blades 145 and the turbine blades 144 are alternately arranged.

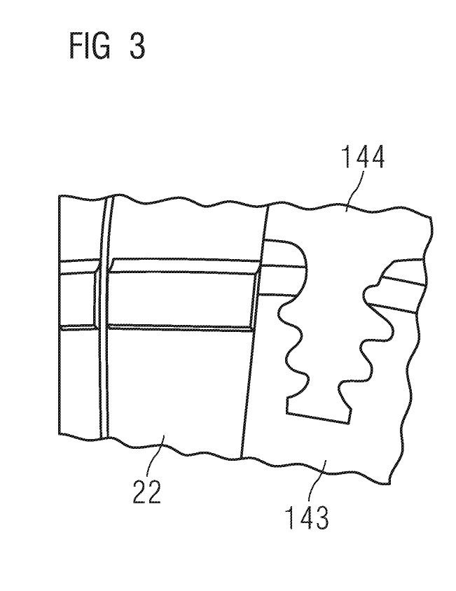

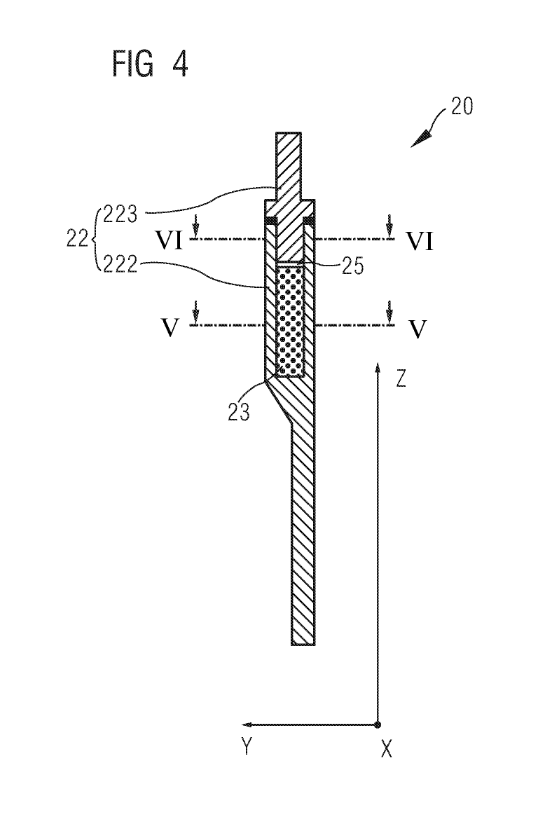

FIG. 3 is a schematic partial diagram of the turbine of the gas turbine shown in FIG. 2. FIG. 4 is a schematic cross-sectional diagram of a sealing cover, along a direction, of the turbine shown in FIG. 3. Referring to FIG. 3 together with FIG. 4, for monitoring of an internal working environment such as a temperature and pressure of the gas turbine 100, a sealing telemetry assembly 20 is further provided within the gas turbine 100, where the sealing telemetry assembly 20 includes a sealing cover 22 and a sensor 23. The sealing cover 22 covers the turbine disk 143, and is located between the rotor 15 and the turbine blade 144. The sealing cover 22 may prevent the turbine disk 143 from being damaged by high temperature air, and may protect the turbine disk 143 effectively. There is also a certain gap between the sealing cover 22 and the turbine disk 143, and cooling air may pass through the gap, to further cool the turbine disk 143.

The sealing cover 22 includes a cavity forming portion 222 and a cover 223, where the cover 223 covers and is fixed to the cavity forming portion 222. A shape and a profile of the sealing cover 22 may be freely designed according to an actual demand, for example, the sealing cover 22 may be further provided with a fastening structure to be fastened to the turbine disk 143. Sealing covers 22 may be used for all sealing covers within the gas turbine 100, or may be used for some sealing covers within the gas turbine 100, that is, the sealing covers 22 and sealing covers in the prior art are cooperatively used.

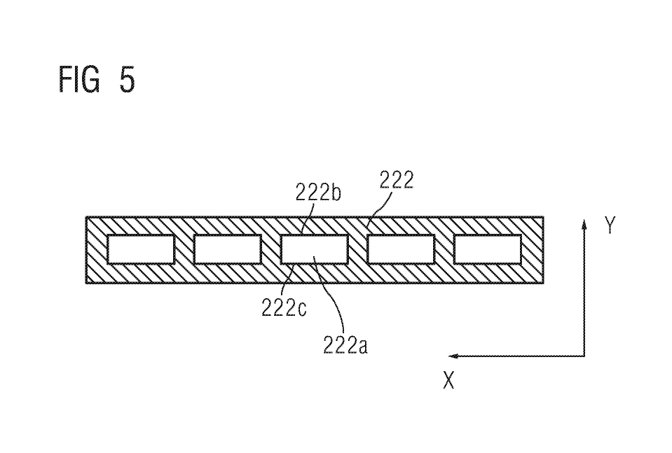

FIG. 5 is a schematic cross-sectional diagram of the sealing cover, shown in FIG. 4, along a line V-V. It should be noted that for ease of description, the sensor 23 and a power supply apparatus 24 is not drawn in FIG. 5. Referring to FIG. 5, at least one installation cavity 222a is provided within the cavity forming portion 222 of the sealing cover 22, the installation cavity 222a is used to accommodate the sensor 23 or power supply apparatus. The installation cavity 222a has a first side wall 222b and a second side wall 222c opposite to the first side wall 222b, where the first side wall 222b and the second side wall 222c extend along a width direction of the sealing cover 22, that is, extend along FIG. 5 an X-axis direction shown in FIG. 5, where the first side wall 222b faces the turbine disk 143, and the second side wall 222c is away from the turbine disk 143.

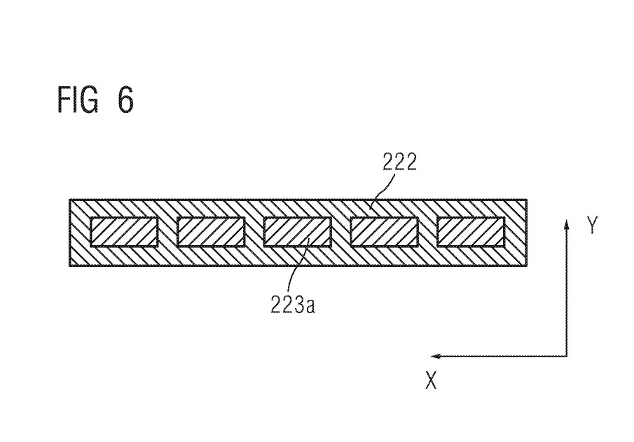

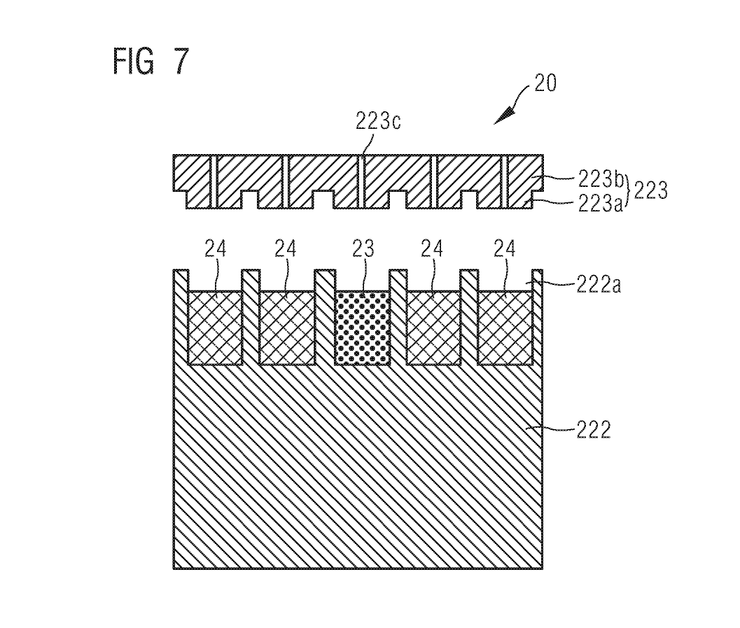

FIG. 6 is a schematic cross-sectional diagram of the sealing cover, shown in FIG. 4, along a line VI-VI. FIG. 7 is a schematic cross-sectional diagram of the sealing cover, along another direction, of the turbine shown in FIG. 3. Referring to FIG. 6, FIG. 7, and FIG. 4, the cover 223 of the sealing cover 22 includes a plurality of protrusion portions 223a and a plurality of flat plate portions 223b, where the protrusion portion 223a is provided at a bottom of the flat plate portion 223b, one protrusion portion 223a corresponds to one installation cavity 222a, and there is a specific distance between adjacent protrusion portions 223a. When the cover 223 covers the cavity forming portion 222, the protrusion portion 223a is accommodated within a corresponding installation cavity 222a, and the flat plate portion 223b is in contact with the top of the cavity forming portion 222. A plurality of wire insertion holes 223c is further provided on the cover 223, where each wire insertion hole 223c passes through the protrusion portion 223a and the flat plate portion 223b, and one wire insertion hole 223 corresponds to one installation cavity 222a, that is, when the cover 223 covers the cavity forming portion 222, the wire insertion hole 223c is in communication with the corresponding installation cavity 222a.

Referring to FIG. 5 and FIG. 7, the sensor 23 may be a pressure sensor or a temperature sensor, but the present invention is not limited thereto. A type of the sensor 23 may be freely set according to an actual demand. The sensor 23 is configured in the installation cavity 222a, when installed, the sensor 23 may be attached to the first side wall 222b or the second side wall 222c, which is determined according to an actual demand. For example, when a temperature of a position near the turbine disk 143 needs to be sensed, the sensor 23 is attached to the first side wall 222b; or when a temperature of a position away from the turbine disk 143 needs to be sensed, the sensor 23 is attached to the second side wall 222c.

Referring to FIG. 3, FIG. 4, and FIG. 7, the sealing telemetry assembly 20 further includes at least one power supply apparatus 24 and at least one spacer 25, where the power supply apparatus 24 is electrically connected to the sensor 23, to supply electric energy to the sensor 23 and a wireless transmitter. The power supply apparatus 24 may be configured in the installation cavity 222a of the sealing cover 22 or is configured outside the sealing cover 22.

In this embodiment, the power supply apparatus 24 is configured in the installation cavity 222a, and is a thermoelectric generator. During a working process of the gas turbine 100, a temperature difference on the sealing cover 22 is relatively large. Because the action of hot air within the gas turbine 100, a temperature of a position near the turbine blade 144 is higher than a temperature of a position near the rotor 15, which causes a radial temperature difference of the sealing cover 22 along Z direction as shown in FIG. 4, that is, a temperature of a position, near the turbine blade 144, of the sealing cover 22 is high, and is generally higher than 400 degrees Celsius or is even close to 500 degrees Celsius to 600 degrees Celsius. In comparison, the temperature of a position of the sealing cover 22 near the rotor 15 is only close to 300 degrees. In addition, because cooling air is also leaded into the gap between the sealing cover 22 and the turbine disk 143, the side of the sealing cover 22 facing to the turbine disk 143 has a relatively low temperature, which also causes a temperature difference along Y direction as shown in FIG. 4. According to the Seebeck effect, a temperature difference of two different electrical conductors or semiconductors may cause voltage difference thermoelectricity, and the thermoelectric generator generates electric energy by using a feature that there is a relatively large temperature difference on the sealing cover 22. The thermoelectric generator may be made of CoSb3 series of thermoelectric materials, where a best working temperature of this type of material is 300 degrees Celsius to 600 degrees Celsius, but the material of the thermoelectric generator is not limited in the embodiments of the present invention.

It should be noted that one sensor 23 and four power supply apparatuses 24 are shown in FIG. 7, but the present invention is not limited thereto. In an actual application, quantities of sensors 23 and power supply apparatuses 24 are determined according to an actual demand. The spacer 25 is disposed between the cover 223 and the sensor 23 or is disposed between the cover 223 and the power supply apparatus 24, to prevent the sensor 23 or the power supply apparatus 24 from moving within the installation cavity 222a.

The sealing telemetry assembly 20 may further include at least one wireless transmitter (not shown in the figure), where the wireless transmitter is electrically connected to the sensor 23 and the power supply apparatus 24. Temperature or pressure data sensed by the sensor 23 may be sent to a control treatment unit by using the wireless transmitter, and the control treatment unit may evaluate working performance and lives of components of the turbine 14 according to the sensed data. The wireless transmitter may be configured in the installation cavity 222a or outside the sealing cover 22. When the wireless transmitter is configured in the installation cavity 222a, a connection line between the wireless transmitter and the sensor 23 and a connection line between the wireless transmitter and the power supply apparatus 24 are both disposed in the installation cavity 222a, and the wire insertion hole 223c on the cover 223 may be omitted; or when the wireless transmitter is configured in outside the installation cavity 222a, a connection line between the wireless transmitter and the sensor 23 and a connection line between the wireless transmitter and the power supply apparatus 24 both need to pass though the wire insertion hole 223c on the cover 223.

Considering that the sealing cover designed in an embodiment of the present invention has a relatively complex structure and has a high requirement on size precision, if the sealing cover is manufactured by using a conventional processing technology, not only processing costs are high, but also mechanical performance and fatigue performance of the sealing cover are reduced due to a large number of related machining and welding processes. Based on the consideration, an additive manufacturing technology controlled by a computer is used in the present invention, which can rapidly and accurately produce and design a component in a complex structure according to a model.

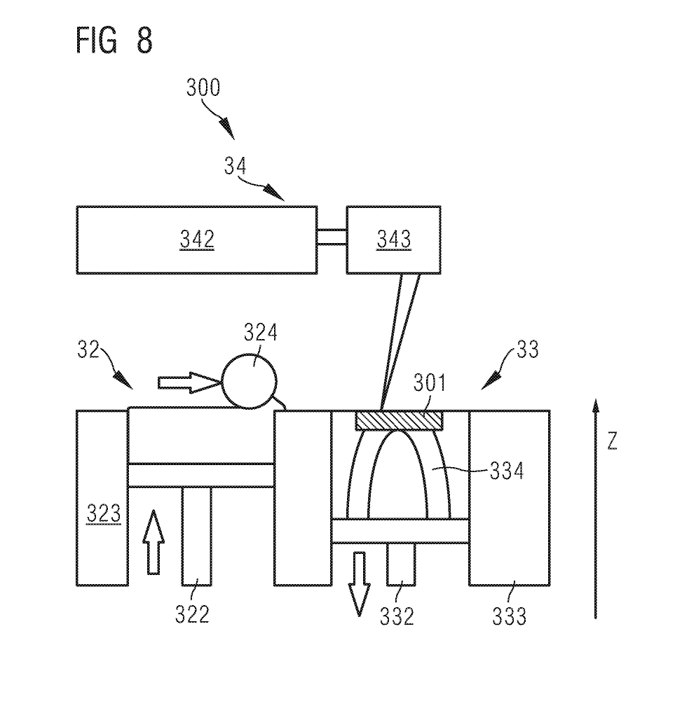

FIG. 8 is a schematic diagram of processing equipment that is used for manufacturing the sealing cover shown in FIG. 4. Referring to FIG. 8, the processing equipment 300 includes a material supply unit 32, a shaping unit 33, and a laser sintering unit 34, where the material supply unit 32 provides powder materials to the shaping unit 33, and the laser sintering unit 34 is used to sinter the powder materials, and make the powder materials to form a profile on the shaping unit 33.

Specifically, the material supply unit 32 includes a supply piston 322, a first cylinder body 323, and a roller 324, where the supply piston 322 is configured in the first cylinder body 323, and may move in a vertical direction along the first cylinder body 323. The powder materials are piled on the supply piston 322. The roller 324 may roll on the powder material, to spread the powder materials on the shaping unit 33. The powder material may be, for example, an Inconel 718 alloy, and the Inconel 718 alloy is a precipitation-hardening nickel-chromium-iron alloy including niobium and molybdenum, and has high strength, desired toughness, and high-temperature performance. The powder material may be further another material having high strength and high-temperature performance.

The shaping unit 33 includes a shaping supply piston 332, a second cylinder body 333, and a shaping portion 334, where the shaping supply piston 332 is configured in the second cylinder body 333, and may move in a vertical direction along the second cylinder body 333; and the shaping portion 334 is fixed to the shaping supply piston 332, and may move in a vertical direction together with the shaping supply piston 332a. The shaping portion 334 is used to bear a to-be-processed component 301.

The laser sintering unit 34 includes a laser 342 and a scanning mirror 343, where the laser 342 is connected to the scanning mirror 343, and may produce a laser beam; and the scanning mirror 343 is used to sinter, by using the laser beam provided by the laser 342, the powder materials to obtain a preset profile.

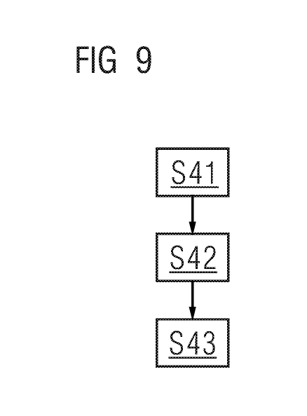

FIG. 9 is a schematic diagram of a manufacturing procedure of the sealing telemetry assembly shown in FIG. 4. Referring to FIG. 9, FIG. 8, and FIG. 4, a manufacturing method of the sealing telemetry assembly 20 includes the following steps:

Step S41: Process the cavity forming portion 222 and the cover by using a 3D printing technology, where a plurality of installation cavities is formed within the cavity forming portion 222.

Step S42: Configure at least one sensor 23 in the installation cavity 222a.

Step S43: Cover or fix the cover 223 on the cavity forming portion 222.

Specifically, in step S41, the 3D printing technology is, for example, selected laser melting (Selected Laser Melting, SLM). The selected laser melting is a rapid prototyping technology of metal powder, and is one of additive manufacturing (Additive manufacturing) technologies. During an actual operation, a roller 324 first spreads a layer of powder materials on a shaping portion 334 of a shaping unit 33. A laser sintering unit 34 controls a laser beam to scan the power layer according to a to-be-shaped profile, so that a temperature of powder rises to a melting point, and sinter the power to form a to-be-processed component 301.

When a cross section is sintered, the shaping supply piston 332 goes down, and in this case, the roller 324 evenly spreads a layer of powder materials on the to-be-processed component 301 again and sintering of another cross section starts. The operation is repeated until the cavity forming portion 222a and the cover 223 are completely formed.

It should be noted that not only the selected laser melting (SLM), but also another 3D printing technology such as a fused deposition modeling (Fused Deposition Modeling, FDM) technology may be used for the sealing telemetry assembly 20, but the SLM is used as an preferable solution because the SLM may provide higher mechanical strength, size precision, and workpiece surface quality.

The cavity forming portion 222 and the cover 223 may be processed on the shaping portion 334 of the shaping unit 33 at the same time, as long as the cavity forming portion 222 is kept separated from the cover 223. The powder material used to shape the cavity forming portion 222 and the cover 223 is a nickel-chromium-iron alloy. It should be noted that in a working process of the sealing cover 20, the sealing cover 20 works under a high temperature for a long term, and is subjected to the action of a relatively large centrifugal force along a length direction (that is, a Z-axis direction shown in FIG. 4, and when the sealing cover 22 covers the turbine disk 143, the length direction extends along a radial direction of the turbine disk 143), which therefore easily causes creep deformation. Because during the 3D printing, the cavity forming portion 222 and the cover 223 are formed by way of stack-up, a proper heat treatment technology is needed to eliminate an inter-layer structure, to improve mechanical performance, especially, high temperature creep resistance performance of the materials. A specific heat treatment technology needs to be determined according to a selected printing material and by way of orthogonal experiment.

The heat treatment technology used in the present invention, for example, 0.5 hours to 2 hours of homogenization treatment under a temperature of 1050 degrees Celsius to 1080 degrees Celsius, air cooling to a temperature of 730 degrees Celsius to 790 degrees Celsius, 5 hours to 20 hours of heat preservation, and furnace cooling to a temperature of 630 degrees Celsius to 680 degrees Celsius and 5 hours to 10 hours of heat preservation. Considering that the material after the heat treatment has best high temperature creep resistance performance in the Z-axis direction, the sealing cover 22 may be printed along the Z-axis direction shown in FIG. 4, that is, the length direction of the sealing cover 22a, but the present invention is not limited thereto. In another embodiment, the sealing cover 22 may also be shaped along an X-axis direction or a Y-axis direction shown in FIG. 4.

Step S41 further includes: when the cover 223 is printed, forming a plurality of wire insertion holes 223c on the cover 223, where when the cover 223 covers the cavity forming portion 222, the wire insertion hole 223c is in communication with a corresponding cavity forming portion 222. It should be noted that, when the wireless transmitter is configured in the installation cavity 222a, the forming of the plurality of wire insertion holes 223c may be omitted.

The power supply apparatus 24 may be also disposed in the sealing cover 22 or be accommodated within the installation cavity 222a. Step S42 further includes: configuring at least one power supply apparatus 24 in the installation cavity 222a, where the power supply apparatus 24 is electrically connected to the sensor 23, and is used to supply power to the sensor 23.

If the wireless transmitter is disposed in the sealing cover 22, step S42 further includes a step of configuring the wireless transmitter configured in the installation cavity 222a. If the wireless transmitter is disposed outside the sealing cover 22, in step S42, a wire connected to the sensor 23 and the power supply apparatus 24 is connected to the wireless transmitter after passing through the wire insertion hole 223c.

In step S43, the cover 223 may be fixed to the cavity forming portion 222 by way of laser welding, but a method for fixing the cover 223 to the cavity forming portion 222 is not limited in the present invention.

The gas turbine, the sealing cover, the sealing telemetry assembly, and the manufacturing method of at least one embodiment of the present invention have at least one of the following advantages:

1. In the gas turbine, the sealing cover, the sealing telemetry assembly, and the manufacturing method thereof of at least one embodiment of the present invention, the sealing cover includes a cavity forming portion and a cover, where a installation cavity is provided within the cavity forming portion, and a sensor may be accommodated within the installation cavity, which can monitor an internal environment of the gas turbine in real time. In addition, in at least one embodiment of the present invention, a power supply apparatus is assembled in the sealing cover, which not only may avoid that a thermal barrier coating is damaged because the power supply apparatus is installed on the thermal barrier coating in the prior art, but also may avoid centrifugal force and magnetic core high temperature demagnetization problems caused by the induction power generation apparatus, so that security and reliability of the gas turbine can be improved. In addition, the sensor transmits a sensing signal in a wireless manner; therefore, no through hole for a wire to pass needs to be provided on a turbine disk, which may reduce production costs.

2. In an embodiment of the gas turbine, the sealing cover, the sealing telemetry assembly, and the manufacturing method thereof of the present invention, the power supply apparatus is a thermoelectric generator, where the thermoelectric generator generates electric energy by using a feature that there is a relatively large temperature difference on the sealing cover, and no external power needs to be connected, which not only may reduce costs of the gas turbine, but also nay facilitate installation.

3. In an embodiment of the gas turbine, the sealing cover, the sealing telemetry assembly, and the manufacturing method thereof of at least one embodiment of the present invention, at least one wireless transmitter may be configured in the installation cavity of the sealing cover or outside the sealing cover, which has a convenient and flexible application.

4. In an embodiment of the gas turbine, the sealing cover, the sealing telemetry assembly, and the manufacturing method thereof of at least one embodiment of the present invention, the cover of the sealing cover is fixed to the cavity forming portion, rather than is integrated with the cavity forming portion, which may increase maintenance convenience. For example, when the power supply apparatus or the sensor within the cavity forming portion break down, the cover may be removed from the cavity forming portion, and after the power supply apparatus or the sensor is repaired, the cover may be then fixed to the cavity forming portion.

5. In an embodiment of the gas turbine, the sealing cover, the sealing telemetry assembly, and the manufacturing method thereof of at least one embodiment of the present invention, the sealing telemetry assembly is processed by using a 3D printing technology; when the sealing cover is produced, the cavity forming portion and the cover are shaped along a length direction of the sealing cover; and then, heat treatment is performed, so that the sealing cover has better mechanical performance, and the sealing cover may be effectively prevented from deformation due to the action of a centrifugal force.

6. In an embodiment of the gas turbine, the sealing cover, the sealing telemetry assembly, and the manufacturing method thereof of at least one embodiment of the present invention, the sealing cover is processed by using a 3D printing technology, so that not only the sealing cover may have better strength, but also a thickness of the sealing cover may be controlled within a preset range, and a thinner sealing cover is obtained.

The foregoing descriptions are merely example embodiments of the present invention, but are not intended to limit the present invention. Any modification, equivalent replacement, or improvement made without departing from the spirit and principle of the present invention should fall within the protection scope of the present invention.

1. A sealing telemetry assembly useable for a gas turbine, the gas turbine including at least one turbine disk, the sealing telemetry assembly comprising:
a sealing cover, the sealing cover being usable to cover the turbine disk, and the sealing cover including:
a cavity forming portion, at least one installation cavity being provided within the cavity forming portion, and
a cover, the cover covering and being fixed to the cavity forming portion; and
at least one power supply apparatus, configured in the at least one installation cavity.

2. The sealing telemetry assembly of claim 1, wherein the cover is provided with a plurality of wire insertion holes such that upon the cover covering the cavity forming portion, a corresponding one of the plurality of wire insertion holes is in communication with corresponding one of the at least one installation cavity.

3. The sealing telemetry assembly of claim 1, further comprising:
at least one sensor, configured in the at least one installation cavity, wherein the at least one power supply apparatus is electrically connected to the at least one sensor.

4. The sealing telemetry assembly of claim 1, wherein the at least one power supply apparatus is a thermoelectric generator.

5. The sealing telemetry assembly of claim 3, further comprising:
at least one spacer, the at least one spacer being disposed between the cover and the at least one sensor or being disposed between the cover and the at least one power supply apparatus.

6. The sealing telemetry assembly of claim 3, further comprising:
at least one wireless transmitter, the at least one wireless transmitter is being electrically connected to the at least one power supply apparatus and the at least one sensor, and being configured in the at least one installation cavity or outside the sealing cover.

7. A sealing cover for a gas turbine, the gas turbine including at least one turbine disk, the sealing cover being usable to cover the turbine disk, and the sealing cover comprising:
a cavity forming portion, at least one installation cavity being provided within the cavity forming portion; and
a cover, the cover being usable to cover and being fixed to the cavity forming portion.

8. The sealing cover of claim 7, wherein the cover is provided with a plurality of wire insertion holes, and wherein, upon the cover covering the cavity forming portion, a corresponding one of the plurality of wire insertion holes is in communication with a corresponding one of the at least one installation cavity.

9. A manufacturing method of a sealing telemetry assembly, the manufacturing method comprising:
processing a cavity forming portion and a cover by using a 3D printing technology, at least one installation cavity being formed within the cavity forming portion;
configuring at least one power supply apparatus in the at least one installation cavity; and
covering or fixing the cover on the cavity forming portion.

10. The manufacturing method of claim 9, further comprising:
shaping the cavity forming portion and the cover along length directions of the cavity forming portion and the cover.

11. The manufacturing method of claim 9, further comprising:
performing heat treatment on the cavity forming portion and the cover.

12. The manufacturing method of a sealing telemetry assembly of claim 9, further comprising:
forming a plurality of wire insertion holes on the cover, upon the cover being printed, wherein when the cover covers the cavity forming portion, a corresponding one of the plurality of the wire insertion holes is in communication with a corresponding one of the at least one installation cavity formed within the cavity forming portion.

13. The manufacturing method of claim 9, further comprising:
configuring at least one sensor in the at least one installation cavity, wherein the power supply apparatus is electrically connected to the sensor and is usable to supply power to the sensor.

14. The manufacturing method of claim 9, wherein a powder material used to shape the cavity forming portion and wherein the cover is a nickel-chromium-iron alloy.

15. A gas turbine, comprising the sealing telemetry assembly of claim 1.

16. The sealing telemetry assembly of claim 2, further comprising:
at least one sensor, configured in the at least one installation cavity, wherein the at least one power supply apparatus is electrically connected to the at least one sensor.

17. The sealing telemetry assembly of claim 16, further comprising:
at least one spacer, the at least one spacer being disposed between the cover and the at least one sensor or being disposed between the cover and the at least one power supply apparatus.

18. The sealing telemetry assembly of claim 16, further comprising:
at least one wireless transmitter, the at least one wireless transmitter being electrically connected to the at least one power supply apparatus and the at least one sensor, and being configured in the at least one installation cavity or outside the sealing cover.

19. The manufacturing method of claim 10, further comprising:
performing heat treatment on the cavity forming portion and the cover.

20. A gas turbine, comprising the sealing telemetry assembly of claim 2.
